(19) United States
(12) Patent Application Publication
(10) Pub. No.: US 2026/0253270 A1
(43) Pub. Date: Aug. 27, 2026

(54) SALIENCY-BASED ADAPTIVE COLOR ENHANCEMENT

(71) Applicant: QUALCOMM Incorporated, San Diego, CA (US)

(72) Inventors: Ruodai CUI, Shanghai (CN); Weixing WAN, Baoshan District (CN); Simiao WU, Shanghai (CN)

(21) Appl. No.: 18/844,923

(22) PCT Filed: Apr. 15, 2022
(86) PCT No.: PCT/CN2022/086994

§ 371 Date: Sep. 6, 2024

(51) Int. Cl. G06T 11/10; G06F 3/01; G06T 3/40; G06V 10/26; G06V 10/46; G06V 10/77

(52) U.S. Cl. CPC G06T 11/10; G06F 3/013; G06T 3/40; G06V 10/26; G06V 10/462; G06V 10/7715

(57) ABSTRACT

Aspects presented herein relate to methods and devices for image processing including an apparatus, e.g., a GPU or DPU. The apparatus may downsample an input image including a plurality of pixels, the downsampled input image corresponding to a downsampled image including a plurality of downsampled pixels. The apparatus may also detect at least one salient object in the downsampled image, the at least one salient object including one or more of the plurality of downsampled pixels. Further, the apparatus may configure a saliency map based on the at least one salient object. The apparatus may also adjust, based on the saliency map, a color value of at least one downsampled pixel of the one or more downsampled pixels in the at least one salient object. Also, the apparatus may tune the input image based on the adjusted color value of the at least one downsampled pixel.

### TECHNICAL FIELD

The present disclosure relates generally to processing systems and, more particularly, to one or more techniques for image processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a display processing unit (DPU), a central processing unit (CPU), or any apparatus that may perform image processing, display processing, or graphics processing. The apparatus may obtain the input image including the plurality of pixels prior to downsampling the input image, where the input image is associated with display processing. The apparatus may also downsample an input image including a plurality of pixels, the downsampled input image corresponding to a downsampled image including a plurality of downsampled pixels. Additionally, the apparatus may analyze the downsampled image with an eye-tracking device, where the at least one salient object is detected based on the analyzed downsampled image. The apparatus may also detect at least one salient object in the downsampled image, the at least one salient object including one or more downsampled pixels of the plurality of downsampled pixels. The apparatus may also configure a saliency map based on the at least one salient object in the downsampled image. Moreover, the apparatus may divide the at least one salient object into a plurality of salient object portions based on a mask, where the mask is associated with the saliency map, and the at least one salient object is divided to adjust the color value of the at least one downsampled pixel. The apparatus may also adjust, based on the saliency map, a color value of at least one downsampled pixel of the one or more downsampled pixels in the at least one salient object. Further, the apparatus may tune the input image based on the adjusted color value of the at least one downsampled pixel. The apparatus may also transmit the tuned input image to a display or a panel; or store the tuned input image in a first memory or a buffer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 is an example graphics processing unit (GPU).

FIG. 3 is a diagram illustrating an example display framework.

FIG. 4 is a diagram illustrating example components for display or image processing.

FIG. 5 is an example saliency map for display processing or image processing.

FIG. 6 is a diagram illustrating an example of a color tuning process.

FIG. 7 is a diagram illustrating another example of a color tuning process.

FIG. 8 is a communication flow diagram illustrating example communications between a DPU, a GPU, and a memory.

FIG. 9 is a flowchart of an example method of graphics processing.

FIG. 10 is a flowchart of an example method of graphics processing.

### DETAILED DESCRIPTION

In aspects of image processing, images may undergo a color tuning process to correct color or brightness deficiencies in the image. For instance, images may be color tuned at certain areas in the image to correct certain deficiencies. The color tuning process may utilize several types of solutions in order to tune the color of the image. In a manual color tuning process, the image may be manually tuned to result in a desired brightness or contrast level of the image. In one aspect of manual tuning, three dimensional (3D) lookup tables (LUTs) (3D LUTs) may be used to map one color space to another color space. For instance, an image may be tuned from an input color to an output color via the use of a 3D LUT. In some instances, the 3D LUTs may be manually tuned in a cumbersome and costly process. Once manually tuned, the LUTs may be fixed for the color of a certain scene, but not adaptive to different scenes. As a result, many different modes in digital cameras and dozens of LUTs in image editing tools may be preset for a user's selection in order to fit different scenes. Although these different modes may present a number of different options, this results in an inconvenient user experience that may need an adjustment for each individual scene. In a deep learning color tuning process, the image may be color tuned based on a process including machine learning (ML) or a neural network (NN). Deep learning processes may use networks that are trainable over a period of time to adjust the color of an image. These types of neural networks may train a network to predict pixel-wise transformations to enhance an input image. However, the computational and memory costs of these types of methods may be too high for practical applications, such as when the resolution of input images is high. Additionally, some deep learning color tuning processes treat each pixel similarly, so there is no way to color tune a specific portion of the image, as the entire image is tuned simultaneously. Aspects of the present disclosure may color tune a specific portion of an image, so that an entire image may not need to be tuned. In some instances, aspects presented herein may utilize salient objects in the image to identify a portion of the image for color tuning. For instance, aspects of the present disclosure may identify the salient objects in an image in order to help with a color tuning process. Moreover, aspects of the present disclosure may utilize a low resolution image for color tuning, such as by downsampling or downscaling an image. By doing so, aspects of the present disclosure may reduce the amount of memory or computing capability utilized for a color tuning process. Aspects presented herein may also utilize an improved color tuning process using a downsampled image for deep learning. This may also improve the color tuning process' resiliency to saliency map edge accuracy, which may further improve the processing speed.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

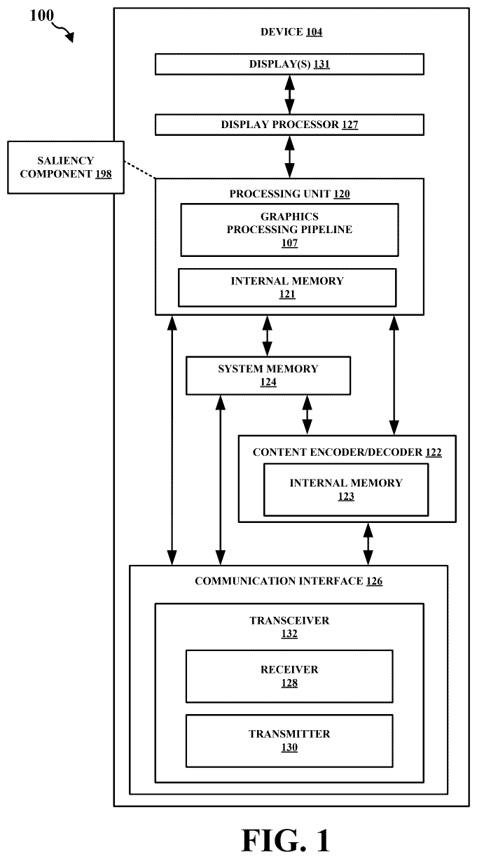

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a saliency component 198 configured to obtain the input image including the plurality of pixels prior to downsampling the input image, where the input image is associated with display processing. The saliency component 198 may also be configured to downsample an input image including a plurality of pixels, the downsampled input image corresponding to a downsampled image including a plurality of downsampled pixels. The saliency component 198 may also be configured to analyze the downsampled image with an eye-tracking device, where the at least one salient object is detected based on the analyzed downsampled image. The saliency component 198 may also be configured to detect at least one salient object in the downsampled image, the at least one salient object including one or more downsampled pixels of the plurality of downsampled pixels. The saliency component 198 may also be configured to configure a saliency map based on the at least one salient object in the downsampled image. The saliency component 198 may also be configured to divide the at least one salient object into a plurality of salient object portions based on a mask, where the mask is associated with the saliency map, and the at least one salient object is divided to adjust the color value of the at least one downsampled pixel. The saliency component 198 may also be configured to adjust, based on the saliency map, a color value of at least one downsampled pixel of the one or more downsampled pixels in the at least one salient object. The saliency component 198 may also be configured to tune the input image based on the adjusted color value of the at least one downsampled pixel. The saliency component 198 may also be configured to transmit the tuned input image to a display or a panel; or store the tuned input image in a first memory or a buffer. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU. Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

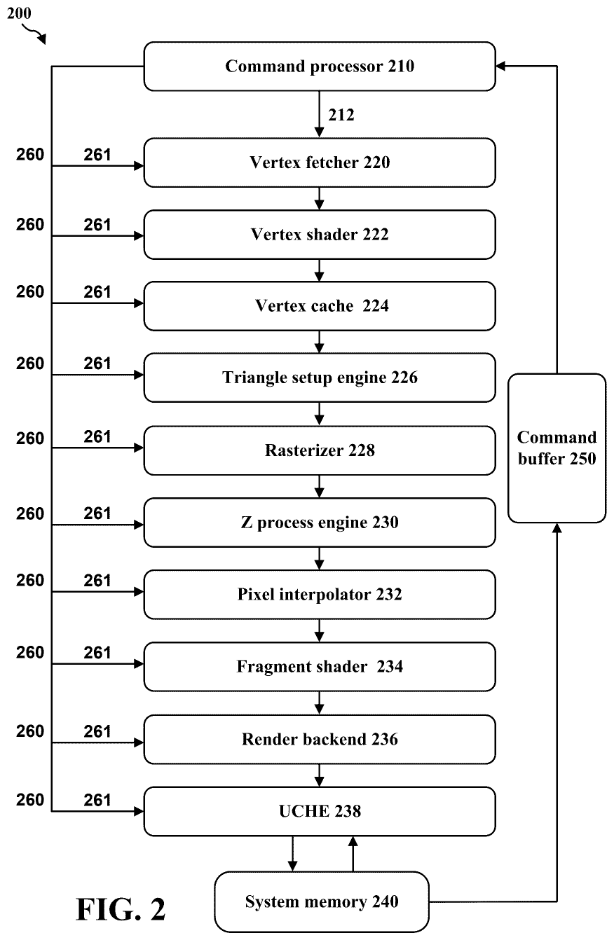

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

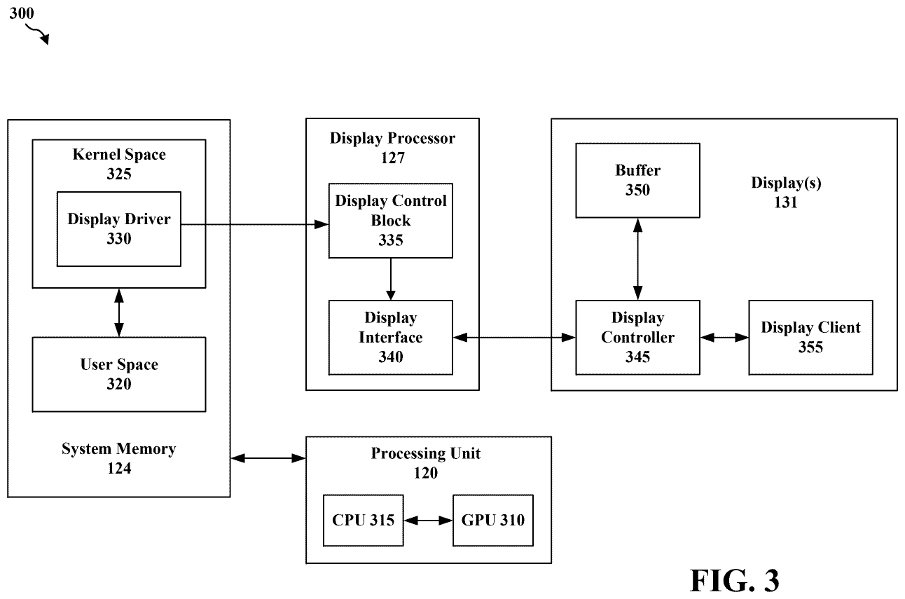

FIG. 3 is a block diagram 300 that illustrates an example display framework including the processing unit 120, the system memory 124, the display processor 127, and the display(s) 131, as may be identified in connection with the exemplary device 104. A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120. The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350. Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355. The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355. Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Composition may be performed via different hardware and/or types of hardware. For example, composition may be performed in association with a display processor (e.g., a DPU), a GPU, and/or a CPU. In some cases, composition may likewise be performed in association with a DSP or other similar hardware blocks. Thus, composition may be performed via a plurality of different hardware or via a single hardware element. The different hardware may perform procedures that cooperate to compose one or more frames. For instance, the display processor and the GPU may cooperate to compose the one or more frames. In a first example, the display processor may compose a first layer of a frame and the GPU may compose the remaining layers of the frame. In a second example, the GPU may compose the first layer of the frame and the display processor may compose the remaining layers of the frame. In a third example, the GPU may compose half of the first layer and the other half of the first layer may be composed by the display processor. Hence, a set of parameters for composing the layers of the frame may be allocated among different hardware in different manners.

The frame composition procedure may be allocated among the different hardware/devices based on the different hardware/devices performing different aspects of the frame composition procedure. For example, the display processor may perform a first aspect of the frame composition and the GPU may perform a second aspect of the frame composition procedure. Determining the allocation of the frame composition procedure may be based on a status of the input (e.g., a status of the different layers) and a status of the output (e.g., a status of a frame to be composed via the frame composition procedure). The input may be indicative of parameters such as resolution, FPS, and other similar parameters. The output may be indicative of the composed frame to be displayed by the display panel. The output may similarly be indicative of the resolution, the FPS, and the other similar parameters.

In aspects of display or image processing, a number of different objects or colors may be adjusted or enhanced in an image or frame. By doing so, the objects or colors in an image may be improved, which may improve the overall appearance of the image. In order to adjust or enhance the objects or colors in an image, the objects or colors may need to be identified prior to the adjustment or enhancement. In some instances, this process may be performed in an image processing pipeline or a display processing pipeline. Moreover, this process may be referred to as an object or color identification process.

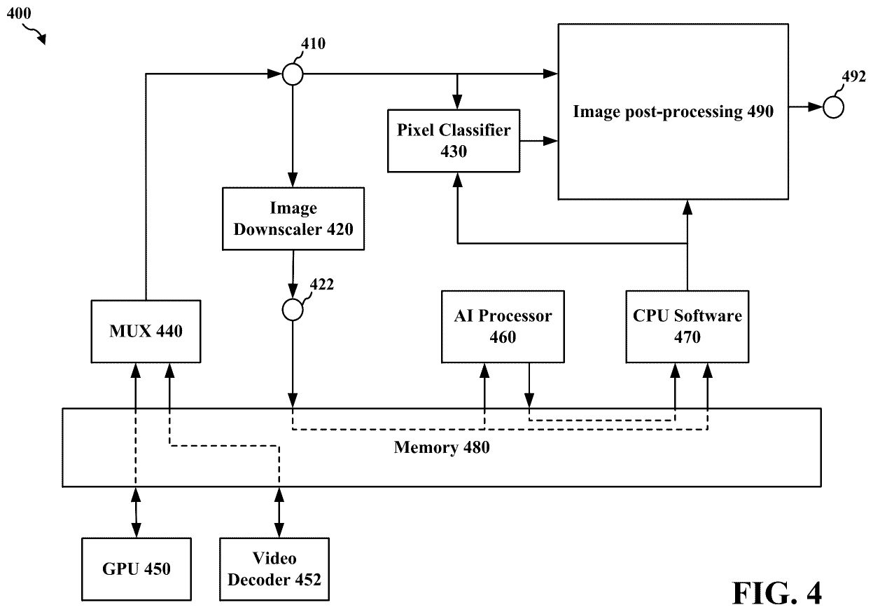

FIG. 4 illustrates a diagram 400 of components for display or image processing. For instance, FIG. 4 illustrates an example structure for an object or color classification process. As shown in FIG. 4, diagram 400 may include input 410, image downscaler 420, frame selection step 422, pixel classifier 430, and multiplexer (MUX) 440. Diagram 400 can also include a content source, which can include a GPU 450 and/or a video decoder 452. Additionally, diagram 400 may include artificial intelligence (AI) processor 460, CPU software 470, memory 480, image post-processing unit 490, and output 492. The input 410 of diagram 400 may include an image or image sequence. Also, the output 492 of diagram 400 may include the image or image sequence after processing.

As shown in FIG. 4, input 410 may communicate with image downscaler 420, pixel classifier 430, and image post-processing unit 490. Also, image downscaler 420 may communicate with frame selection step 422, e.g., to select a frame or image. Further, frame selection step 422 may communicate, e.g., a reduced resolution image, with AI processor 460 and/or CPU software 470, e.g., via memory 480. AI processor 460 may also communicate with CPU software 470 via memory 480. GPU 450 and video decoder 452 may communicate with MUX 440, e.g., via memory 480. MUX 440 may also communicate with input 410. Also, CPU software 470 may communicate with pixel classifier 430, e.g., a configuration update, and/or image post-processing unit 490. Pixel classifier 430 may also communicate with image post-processing unit 490. After this, image post-processing unit 490 may communicate with the output 492, e.g., an image or image sequence.

As further depicted in FIG. 4, the image post-processing unit 490 may be pre-frame composition or post-frame composition. In some aspects, diagram 400 may include a low-power real-time pixel processing pipeline, which may include input 410, image downscaler 420, pixel classifier 430, and/or image post-processing unit 490. Also, diagram 400 may include non-real-time processing, which may be performed on selected images or frames. This non-real-time processing may include frame selection step 422, MUX 440, GPU 450, video decoder 452, AI processor 460, CPU software 470, and memory 480. In some aspects, AI processor 460 may be referred to as a neural network processor. Also, the CPU software 470 may be utilized for a statistical analysis.

Some aspects of display processing utilize a number of visualization techniques for computing images, e.g., saliency maps. Saliency maps utilize the concept of saliency in images, where saliency may refer to a number of features, e.g., pixels, resolution, etc., of an image or frame in the context of display processing. The aforementioned features may depict the visually alluring locations, i.e., the ‘salient’ locations, in an image or frame. Saliency maps are topographical representations of these visually alluring or salient locations in an image or frame. For instance, saliency maps can help to highlight the foreground of an image compared to the background of an image. In some instances, a neural network (NN) or a convolutional neural network (CNN) may be utilized to generate a saliency map.

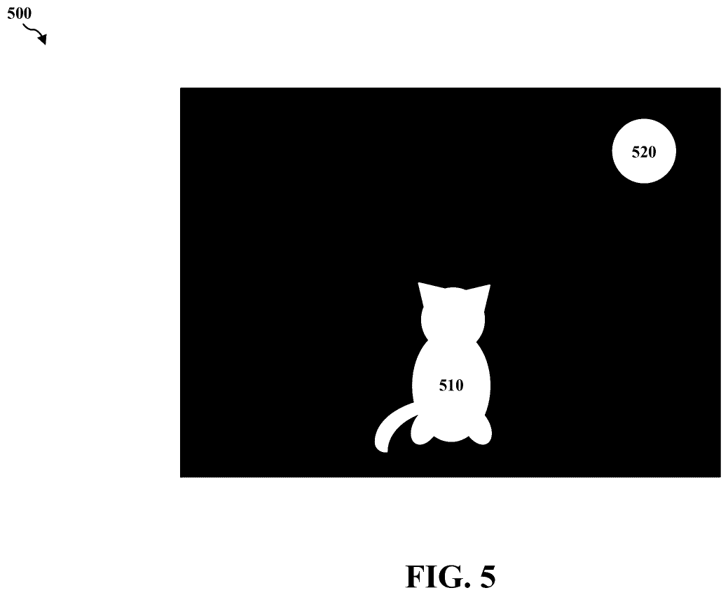

FIG. 5 is an example saliency map 500 for display processing or image processing. As illustrated in FIG. 5, saliency map 500 corresponds to a respective image or photographic image. For instance, FIG. 5 is a saliency map 500 for a photographic image including a cat 510 and a moon 520. As shown in FIG. 5, saliency maps highlight the objects of interest, i.e., the salient objects, in an image. As depicted by saliency map 500, the cat 510 and the moon 520 are the objects of interest, i.e., the salient objects, in the corresponding photographic image.

In aspects of image processing, images may undergo a color tuning process to correct color or brightness deficiencies in the image. For instance, images may be color tuned at certain areas in the image to correct certain deficiencies. That is, images may be automatically color tuned at certain areas in the image, such as dark and/or overexposed areas of the image. The color tuning process may utilize several types of solutions in order to tune the color of the image. In one aspect, the color tuning process may be a manual tuning process where the color of an image is manually tuned to a certain specification. Additionally, the color tuning process may be a deep learning process including machine learning (ML) or a neural network (NN).

In a manual color tuning process, the image may be manually tuned to result in a desired brightness or contrast level of the image. For example, the contrast of an image may be increased or decreased by a certain amount (e.g., increased/decreased by 40% contrast) in order to obtain the desired level of contrast. Likewise, the brightness of an image may be increased or decreased by a certain amount (e.g., increased/decreased by 40% brightness) in order to obtain the desired level of brightness. In one aspect of manual tuning, three dimensional (3D) lookup tables (LUTs) (3D LUTs) may be used to map one color space to another color space. A 3D LUT is a 3D lattice of output color values (e.g., red, green, blue (RGB) color values) that may be indexed by sets of input color values (e.g., RGB color values). For instance, an image may be tuned from an input color to an output color via the use of a 3D LUT. In some instances, the 3D LUTs may be manually tuned in a cumbersome and costly process. Once manually tuned, the LUTs may be fixed for the color of a certain scene, but not adaptive to different scenes. As a result, many different modes in digital cameras and dozens of LUTs in image editing tools may be preset for a user's selection in order to fit different scenes. Although these different modes may present a number of different options, this results in an inconvenient user experience that may need an adjustment for each individual scene.

In a deep learning color tuning process, the image may be color tuned based on a process including machine learning (ML) or a neural network (NN). Deep learning processes may use networks that are trainable over a period of time to adjust the color of an image. For instance, a deep learning process may utilize a pixel-to-pixel neural network that takes into account the pixels of an image. These types of neural networks may train a network to predict pixel-wise transformations to enhance an input image. For example, a pixel-to-pixel neural network may input a high resolution (high-res) image and output a high resolution image that includes color-tuned pixels. However, the computational and memory costs of these types of methods may be too high for practical applications, such as when the resolution of input images is high. For example, for an image taken by a mobile phone equipped with a sensor including 48 megapixels, a memory of 0.54 GB may be needed to store one single input RGB image with a certain data type (e.g., a float32 data type). This may result in hundreds of billions of floating point operations (FLOPs) and more than 20 GB of memory for the pixel-wise methods to process this type of high resolution image.

Additionally, some deep learning color tuning processes treat each pixel similarly, so there is no way to color tune a specific portion of the image, as the entire image is tuned simultaneously. Based on the above, it may be beneficial to color tune a specific portion of an image, so that an entire image may not need to be tuned. Also, it may be beneficial to utilize salient objects in the image to identify a portion of the image for color tuning. In order to do so, it may be beneficial to identify the salient objects in an image. Further, it may be beneficial to utilize a low resolution image for color tuning, such as by downsampling or downscaling an image. For instance, it may be beneficial to reduce the amount of memory or computing capability utilized for a color tuning process.

Aspects of the present disclosure may color tune a specific portion of an image, so that an entire image may not need to be tuned. In some instances, aspects presented herein may utilize salient objects in the image to identify a portion of the image for color tuning. For instance, aspects of the present disclosure may identify the salient objects in an image in order to help with a color tuning process. Moreover, aspects of the present disclosure may utilize a low resolution image for color tuning, such as by downsampling or downscaling an image. By doing so, aspects of the present disclosure may reduce the amount of memory or computing capability utilized for a color tuning process. Aspects presented herein may also utilize an improved color tuning process using a downsampled image for deep learning. This may also improve the color tuning process' resiliency to saliency map edge accuracy, which may further improve the processing speed.

Aspects presented herein may utilize a deep learning model (e.g., a neural network or machine learning model) that downsamples or downscales an image as part of a color tuning process. This downsampling or downscaling may be performed prior to detecting salient objects in an image, such that a low resolution image may be utilized for the color tuning process. Also, the detection of salient objects in the image may help to improve the accuracy of the color tuning process. As mentioned herein, salient objects may be more noticeable or conspicuous to a human eye compared to other objects in an image. By adjusting a color value of pixels in salient objects in an image, rather than other objects in the image, the color tuned image may be more accurate to the human eye. Indeed, color tuning the pixels of salient objects may be more important for image quality than color tuning the pixels of other objects in an image. In some instances, aspects presented herein may detect salient objects in an image in a preprocessing step, such as prior to actually tuning the color of pixels in the salient objects. Further, by adjusting a color value of pixels in salient objects in an image, rather than all the objects in an image, the amount of color tuning work may be reduced compared to other color tuning approaches. As such, this may utilize a reduced amount of memory or computing capability during the color tuning process (e.g., a reduced amount of memory or computing capability at a graphics processing unit (GPU)). That is, color tuning approaches of the present disclosure may improve the speed and/or accuracy of the color tuning process compared to other types of color tuning.

Additionally, compared to other color tuning methods, aspects presented herein may provide a faster color tuning since it utilizes a low resolution image, rather than a high resolution image. Further, as mentioned above, aspects presented herein may utilize a lower amount of memory and computing capability of a GPU. Also, aspects presented herein may provide a practical color tuning solution for certain types of devices (e.g., mobile devices or smart phones). For instance, as aspects presented herein may just focus on tuning pixel colors, aspects presented herein may utilize input images in a lower resolution compared to other color tuning approaches. For instance, aspects presented herein may utilize low resolution input images, while other approaches may utilize high resolution input images. Moreover, aspects presented herein may produce improved color tuning results in specific areas of an image, such as areas that utilize local color enhancement or color enhancement of salient objects in an image. These improved color tuning results may be applicable to areas in an image that have experienced overexposure.

As indicated herein, aspects of the present disclosure may not treat every pixel equally for color tuning. For instance, aspects presented herein may identify certain pixels (i.e., pixels of salient objects) for color tuning. That is, aspects presented herein may identify the local areas in an image that can best draw attention from a human eye. Aspects presented herein may detect a salient object in an image, and then use the salient object as an input to a 3D LUT network (e.g., rather than the whole image as an input) for color tuning. The result of inputting salient objects to the 3D LUT network for color tuning is that the color tuning of salient pixels may be more clear compared to other pixels. For example, if certain pixels (i.e., salient pixels) are brighter than other pixels (i.e., non-salient pixels) in an image, then aspects presented herein may allow these pixels to remain brighter after color tuning the image.

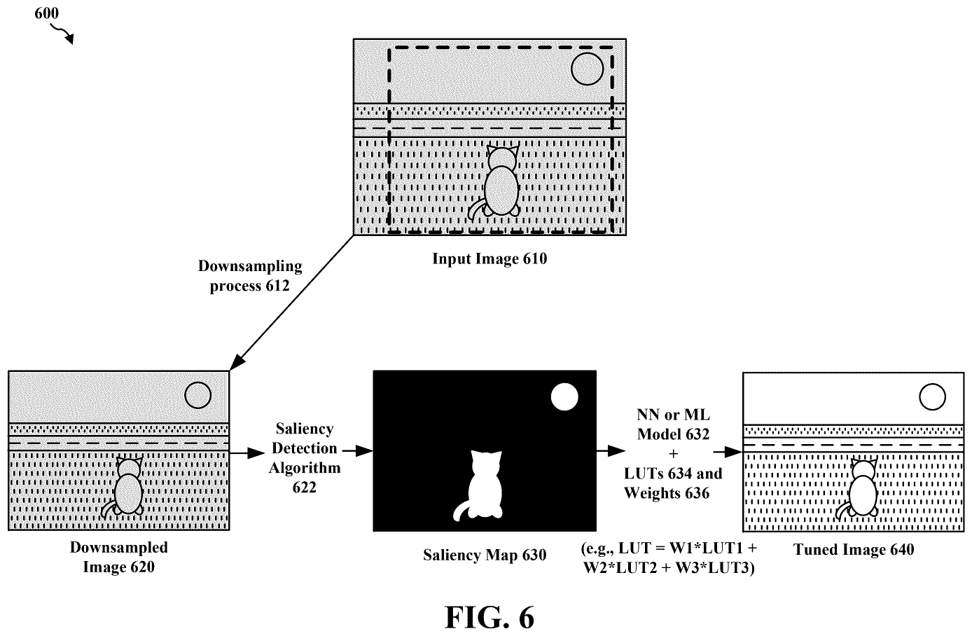

FIG. 6 illustrates diagram 600 including one example of a color tuning process. More specifically, diagram 600 in FIG. 6 shows an example of tuning color values of pixels in a downsampled image. As shown in FIG. 6, diagram 600 includes input image 610 including content (e.g., a cat and a moon), downsampled image 620 including similar content (e.g., a cat and a moon), saliency map 630, and tuned image 640 including similar content (e.g., a cat and a moon) that has been tuned. Diagram 600 also includes downsampling process 612 that is performed on input image 610. Additionally, diagram 600 in FIG. 6 includes a saliency detection algorithm 622, as well as a neural network or machine learning model 632, LUTs 634, and weights 636. The color tuning process in FIG. 6 may be performed in a number of different processing units for image processing (e.g., a GPU or a DPU).

FIG. 6 depicts a color tuning process that utilizes a low resolution image (i.e., a downsampled or downscaled image) prior to detecting the salient objects in an image. For instance, input image 610 may be downsampled or downscaled during downsampling process 612. The downsampling process 612 may result in downsampled image 620. Next, aspects presented herein may perform a saliency detection algorithm 622 on downsampled image 620. This may result in the detection of the salient objects in downsampled image 620. Based on the salient objects in downsampled image 620, aspects presented herein may configure a saliency map 630. As shown in FIG. 6, the saliency map 630 may highlight the salient objects in the image (i.e., the white objects in saliency map 630).

As further shown in FIG. 6, after configuring the saliency map 630, aspects presented herein may divide the salient objects into multiple salient object portions. This may be performed using a mask associated with the saliency map 630. Additionally, the salient objects may be divided into multiple salient object portions based on a neural network or machine learning model 632. Next, aspects presented herein may adjust a color value of downsampled pixels in the salient objects based on the saliency map 630. The color value of the downsampled pixels may be adjusted based on LUTs 634 (e.g., 3D LUTs) and weights 636 for the color value of the downsampled pixels. As shown in FIG. 6, the LUTs 634 may include a first 3D LUT (LUT1), a second 3D LUT (LUT2), and a third 3D LUT (LUT3), and the weights 636 may include a first weight (W1), a second weight (W2), and a third weight (W3). In some instances, the color value of the downsampled pixels may be adjusted based on the following formula: W1*LUT1+W2*LUT2+W3*LUT3. Finally, aspects presented herein may tune the input image based on the adjusted color value of the downsampled pixels, thus resulting in tuned image 640. The tuned image 640 may be transmitted to a display or panel, as well as stored in a memory or buffer. As shown in FIG. 6, aspects presented herein may utilize a deep learning technique to train 3D LUTs.

The images that are produced from color tuning processes utilizing saliency detection (e.g., the color tuning process in FIG. 6) may be clearer than images than undergo color tuning without saliency detection. For instance, aspects of the present disclosure that utilize color tuning processes with saliency detection may improve color tuning results because specific portions of images are locally enhanced. Also, by detecting salient objects in an image, aspects of the present disclosure may color tune specific portions of an image. This may result in a more accurate and optimized color tuning approach, such as images with clearer salient objects (i.e., the subject matter of an image that is more noticeable and conspicuous compared to other objects in the image).

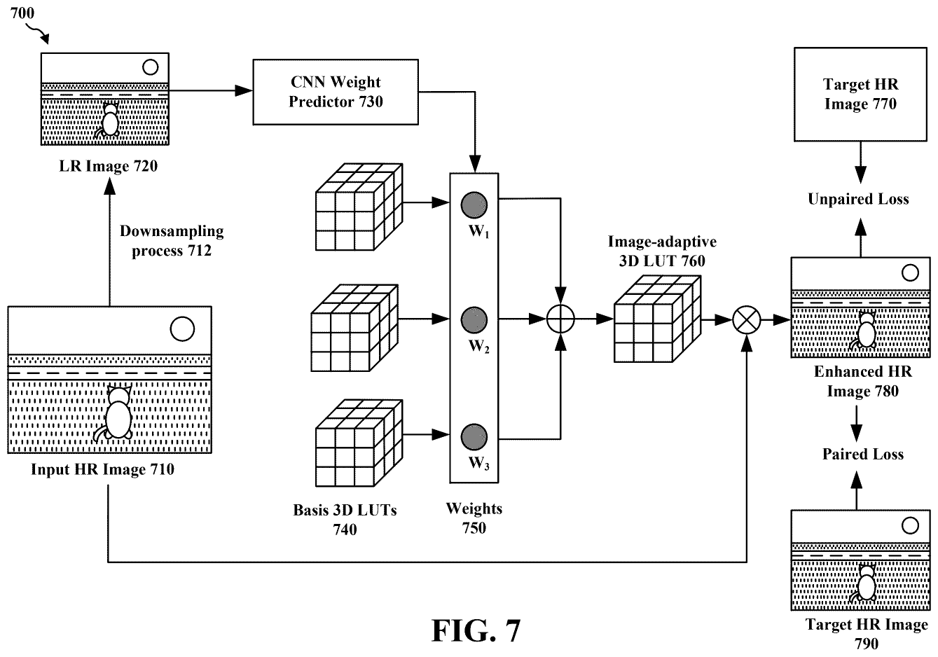

FIG. 7 illustrates diagram 700 including another example of a color tuning process. More specifically, diagram 700 in FIG. 7 shows an example of tuning color values of pixels in an image. As shown in FIG. 7, diagram 700 includes input high resolution (HR) image 710, low resolution (LR) image 720, convolutional neural network (CNN) weight predictor 730, basis 3D LUTs 740, weights 750 (including first weight (W1), second weight (W2), and third weight (W3)), and image-adaptive 3D LUT 760. Diagram 700 also includes a number of output images, such as sample target HR image 770, enhanced HR image 780, and specified target HR image 790. FIG. 7 depicts that input high resolution (HR) image 710 goes through downsampling process 712 to produce low resolution (LR) image 720. Next, low resolution (LR) image 720 is fed to convolutional neural network (CNN) weight predictor 730, which then utilizes basis 3D LUTs 740 and weights 750. After a concatenation, this result is fed to image-adaptive 3D LUT 760. Further, this result is combined with input high resolution (HR) image 710 to produce enhanced HR image 780. Combining the enhanced HR image 780 with sample target HR image 770 produces an unpaired loss. Moreover, combining the enhanced HR image 780 with specified target HR image 790 produces a paired loss.

In some instances, aspects presented herein may apply monotonicity regularization to preserve the relative brightness and saturation of input color values (e.g., input RGB values). This process may be utilized to avoid artifacts in the images. In some aspects, monotonicity regularization may result in too much brightness for certain objects in an image. Additionally, color tuning models that do not utilize saliency detection may focus more on the background pixels and less on the salient object pixels. For instance, without saliency detection, color tuning models may increase the brightness of a salient object too much, as these models may make the background objects brighter simultaneously. However, with saliency detection, color tuning models presented herein may increase the brightness of a salient object by an ideal amount. The saliency detection models according to the present disclosure may focus on the salient objects in an image and produce an ideal, soft color for the salient objects in an image.

Additionally, aspects presented herein may instantiate different color tuning models. For example, aspects presented herein may instantiate two models of a saliency detection algorithm in order to facilitate usage in different environments. These models of a saliency detection algorithm may achieve competitive performance on certain datasets (e.g., salient objection detection (SOD) datasets). Further, aspects presented herein may utilize certain formulas for salient object detection. For example, aspects presented herein may utilize the following formula:

$$arg max f ( \frac{{\sum }_{pixels in salient object} pixels * saliency weight}{{\sum }_{pixels in background} pixels} ) ,$$

where saliency weight is the probability that one pixel is in a saliency object. In some instances, this formula may be computed by a saliency detection algorithm, so self-supervised training may be performed without any manually labeling. For instance, all none-zero saliency weights may be set to a certain value (e.g., one (1)), which corresponds to certain salient objects in an image (e.g., a person's head and clothes). As some salient objects in an image have more pixels then other salient objects, aspects presented herein may determine the biggest color difference in the salient objects.

In some aspects, color tuning models according to the present disclosure may not need a highly accurate edge of a saliency map, as the models may just be concerned with the colors of the pixel. As such, color tuning models according to the present disclosure may attempt to increase the processing speed, even with some drop in accuracy. In some instances, there may be a certain amount of 3D LUTs (e.g., three initial 3D LUTs) for a color tuning network. If the size of the 3D LUT feature is expanded, color tuning models according to the present disclosure may determine more combinations of the LUTs. Additionally, aspects presented herein may utilize pairwise learning, i.e., when a set of input images and their corresponding (human annotated) ground truth images are available, supervised learning methods may be utilized to learn the photo enhancement model. Aspects presented herein may employ mean squared error (MSE) loss to train the color tuning models. Also, aspects presented herein may utilize unpaired learning, i.e., unsupervised learning of deep models using unpaired data.

Aspects of the present disclosure may include a number of benefits or advantages. For instance, aspects presented herein may use a low resolution picture by downsampling or downscaling the image. As such, aspects presented herein may utilize a lower amount of memory or computing capability compared to other color tuning approaches. Additionally, aspects presented herein may produce improved color tuning results because specific portions of images are locally enhanced. For example, by detecting salient objects in an image, aspects of the present disclosure may color tune specific portions of an image. By doing so, aspects presented herein may provide a more accurate and optimized color tuning approach, as well as utilize a lower amount of memory or computing capability compared to other color tuning approaches. Further, compared to other deep learning methods, color tuning models presented herein may be faster, as the models presented herein may utilize low-resolution pictures and utilize much lower memory and computing capability of a GPU. Accordingly, color tuning models presented herein may provide a promising practical solution to color tuning devices (e.g., mobile devices or smart phones). Moreover, compared to some 3D LUTs, color tuning models presented herein may produce better results in salient areas that utilize local enhancement, especially for overexposed areas of an image caused by monotonicity regularization.

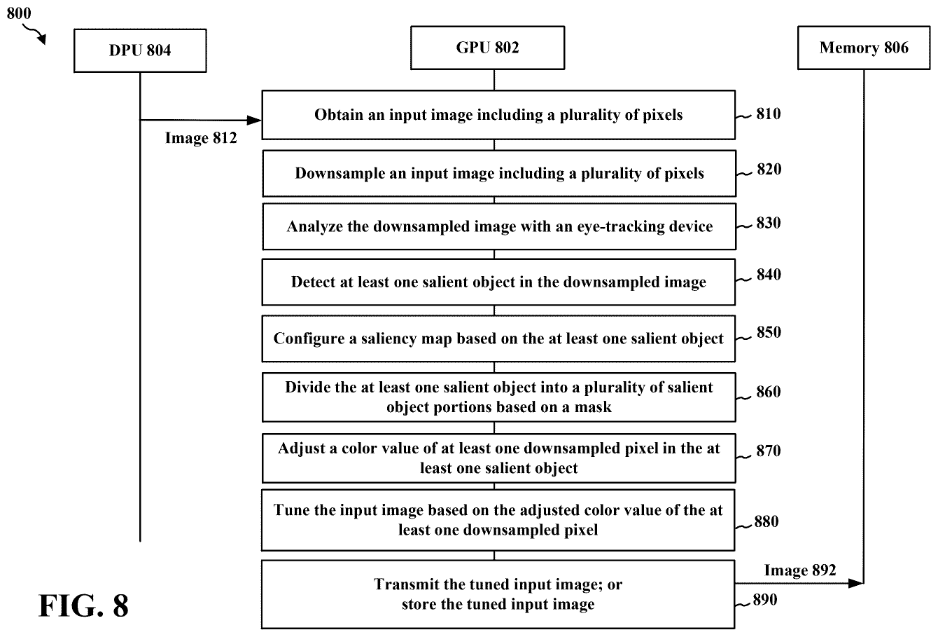

FIG. 8 is a communication flow diagram 800 of graphics processing in accordance with one or more techniques of this disclosure. As shown in FIG. 8, diagram 800 includes example communications between DPU 804 and components of a GPU (or other graphics processor), e.g., GPU 802 and memory 806 (e.g., system memory, double data rate (DDR) memory, or video memory), in accordance with one or more techniques of this disclosure.

At 810, GPU 802 may obtain the input image including the plurality of pixels (e.g., receive image 812 from DPU 804), where the input image is associated with display processing.

At 820, GPU 802 may downsample an input image including a plurality of pixels, the downsampled input image corresponding to a downsampled image including a plurality of downsampled pixels. The input image may be a high resolution image and the downsampled image may be a low resolution image. For example, the high resolution image may include greater than 300 pixels per inch (ppi) and the low resolution image may include less than 300 ppi.

At 830, GPU 802 may analyze the downsampled image with an eye-tracking device, where the at least one salient object is detected based on the analyzed downsampled image.

At 840, GPU 802 may detect at least one salient object in the downsampled image, the at least one salient object including one or more downsampled pixels of the plurality of downsampled pixels. The at least one salient object may be detected with a saliency detection algorithm. Also, the at least one salient object may be detected based on at least one saliency dataset of a ground truth of pixels. Further, detecting the at least one salient object in the downsampled image may include: processing the plurality of downsampled pixels in the downsampled image. The at least one salient object may be more noticeable or conspicuous to a human eye compared to one or more other objects in the downsampled image.

At 850, GPU 802 may configure a saliency map based on the at least one salient object in the downsampled image. The saliency map may be configured based on a portion of the at least one salient object, such that the saliency map is configured based on less than all of the at least one salient object.

At 860, GPU 802 may divide the at least one salient object into a plurality of salient object portions based on a mask, where the mask is associated with the saliency map, and the at least one salient object is divided to adjust the color value of the at least one downsampled pixel. The at least one salient object may be divided into the plurality of salient object portions further based on a neural network (NN) or a machine learning (ML) model.

At 870, GPU 802 may adjust, based on the saliency map, a color value of at least one downsampled pixel of the one or more downsampled pixels in the at least one salient object. The color value of the at least one downsampled pixel may be adjusted based on one or more of: at least one three dimensional (3D) lookup table (LUT) or one or more weights for the color value of the plurality of downsampled pixels. In some aspects, the at least one 3D LUT may include a plurality of 3D LUTs and the one or more weights may include a plurality of weights, where the color value of the at least one downsampled pixel may be adjusted based on a product of at least one of the plurality of 3D LUTs and at least one of the plurality of weights.

At 880, GPU 802 may tune the input image based on the adjusted color value of the at least one downsampled pixel. Tuning the input image based on the adjusted color value of the at least one downsampled pixel may include: enhancing the input image based on the adjusted color value of the at least one downsampled pixel.

At 890, GPU 802 may transmit the tuned input image to a display or a panel; or store the tuned input image in a first memory or a buffer (e.g., store image 892 in memory 806).

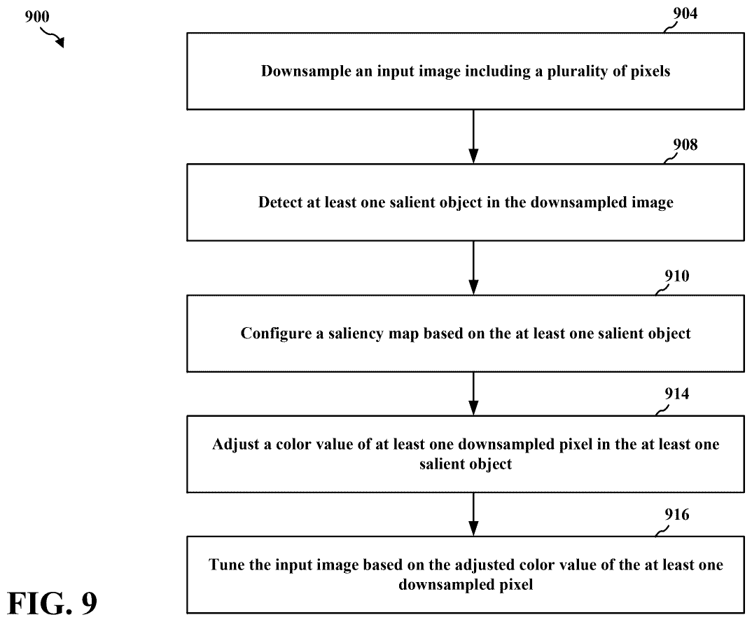

FIG. 9 is a flowchart 900 of an example method of graphics processing in accordance with one or more techniques of this disclosure. The method may be performed by a GPU, such as an apparatus for image or graphics processing, an image or graphics processor, a DPU, a CPU, a wireless communication device, and/or any apparatus that may perform image or graphics processing as used in connection with the examples of FIGS. 1-8. The methods described herein may provide a number of benefits, such as improving resource utilization and/or power savings.

At 904, the GPU may downsample or downscale an input image including a plurality of pixels, the downsampled input image corresponding to a downsampled image including a plurality of downsampled pixels, as described in connection with the examples in FIGS. 1-8. For example, as described in 820 of FIG. 8, GPU 802 may downsample or downscale an input image including a plurality of pixels, the downsampled input image corresponding to a downsampled image including a plurality of downsampled pixels. Further, step 904 may be performed by processing unit 120 in FIG. 1. The input image may be a high resolution image and the downsampled image may be a low resolution image. For example, the high resolution image may include greater than 300 pixels per inch (ppi) and the low resolution image may include less than 300 ppi.

At 908, the GPU may detect at least one salient object in the downsampled image, the at least one salient object including one or more downsampled pixels of the plurality of downsampled pixels, as described in connection with the examples in FIGS. 1-8. For example, as described in 840 of FIG. 8, GPU 802 may detect at least one salient object in the downsampled image, the at least one salient object including one or more downsampled pixels of the plurality of downsampled pixels. Further, step 908 may be performed by processing unit 120 in FIG. 1. The at least one salient object may be detected with a saliency detection algorithm. Also, the at least one salient object may be detected based on at least one saliency dataset of a ground truth of pixels. Further, detecting the at least one salient object in the downsampled image may include: processing the plurality of downsampled pixels in the downsampled image. The at least one salient object may be more noticeable or conspicuous to a human eye compared to one or more other objects in the downsampled image.

At 910, the GPU may configure a saliency map based on the at least one salient object in the downsampled image, as described in connection with the examples in FIGS. 1-8. For example, as described in 850 of FIG. 8, GPU 802 may configure a saliency map based on the at least one salient object in the downsampled image. Further, step 910 may be performed by processing unit 120 in FIG. 1. The saliency map may be configured based on a portion of the at least one salient object, such that the saliency map is configured based on less than all of the at least one salient object.

At 914, the GPU may adjust, based on the saliency map, a color value of at least one downsampled pixel of the one or more downsampled pixels in the at least one salient object, as described in connection with the examples in FIGS. 1-8. For example, as described in 870 of FIG. 8, GPU 802 may adjust, based on the saliency map, a color value of at least one downsampled pixel of the one or more downsampled pixels in the at least one salient object. Further, step 914 may be performed by processing unit 120 in FIG. 1. The color value of the at least one downsampled pixel may be adjusted based on one or more of: at least one three dimensional (3D) lookup table (LUT) or one or more weights for the color value of the plurality of downsampled pixels. In some aspects, the at least one 3D LUT may include a plurality of 3D LUTs and the one or more weights may include a plurality of weights, where the color value of the at least one downsampled pixel may be adjusted based on a product of at least one of the plurality of 3D LUTs and at least one of the plurality of weights.

At 916, the GPU may tune the input image based on the adjusted color value of the at least one downsampled pixel, as described in connection with the examples in FIGS. 1-8. For example, as described in 880 of FIG. 8, GPU 802 may tune the input image based on the adjusted color value of the at least one downsampled pixel. Further, step 916 may be performed by processing unit 120 in FIG. 1. Tuning the input image based on the adjusted color value of the at least one downsampled pixel may include: enhancing the input image based on the adjusted color value of the at least one downsampled pixel.

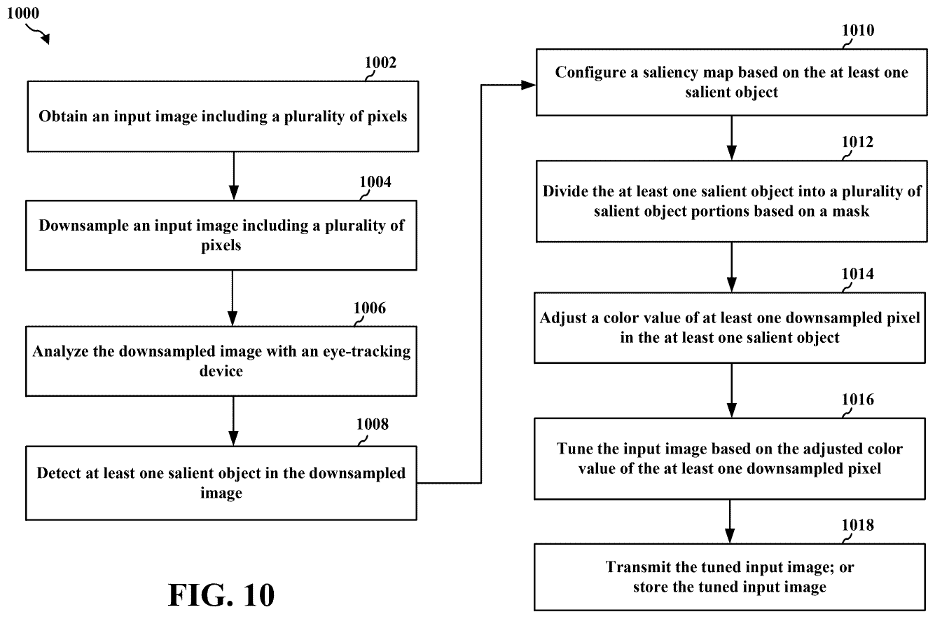

FIG. 10 is a flowchart 1000 of an example method of graphics processing in accordance with one or more techniques of this disclosure. The method may be performed by a GPU, such as an apparatus for image or graphics processing, an image or graphics processor, a DPU, a CPU, a wireless communication device, and/or any apparatus that may perform image or graphics processing as used in connection with the examples of FIGS. 1-8. The methods described herein may provide a number of benefits, such as improving resource utilization and/or power savings.

At 1002, the GPU may obtain the input image including the plurality of pixels, where the input image is associated with image processing or display processing, as described in connection with the examples in FIGS. 1-8. For example, as described in 810 of FIG. 8, GPU 802 may obtain the input image including the plurality of pixels, where the input image is associated with image processing or display processing. Further, step 1002 may be performed by processing unit 120 in FIG. 1.

At 1004, the GPU may downsample or downscale an input image including a plurality of pixels, the downsampled input image corresponding to a downsampled image including a plurality of downsampled pixels, as described in connection with the examples in FIGS. 1-8. For example, as described in 820 of FIG. 8, GPU 802 may downsample or downscale an input image including a plurality of pixels, the downsampled input image corresponding to a downsampled image including a plurality of downsampled pixels. Further, step 1004 may be performed by processing unit 120 in FIG. 1. The input image may be a high resolution image and the downsampled image may be a low resolution image. For example, the high resolution image may include greater than 300 pixels per inch (ppi) and the low resolution image may include less than 300 ppi.

At 1006, the GPU may analyze the downsampled image with an eye-tracking device, where the at least one salient object is detected based on the analyzed downsampled image, as described in connection with the examples in FIGS. 1-8. For example, as described in 830 of FIG. 8, GPU 802 may analyze the downsampled image with an eye-tracking device, where the at least one salient object is detected based on the analyzed downsampled image. Further, step 1006 may be performed by processing unit 120 in FIG. 1.

At 1008, the GPU may detect at least one salient object in the downsampled image, the at least one salient object including one or more downsampled pixels of the plurality of downsampled pixels, as described in connection with the examples in FIGS. 1-8. For example, as described in 840 of FIG. 8, GPU 802 may detect at least one salient object in the downsampled image, the at least one salient object including one or more downsampled pixels of the plurality of downsampled pixels. Further, step 1008 may be performed by processing unit 120 in FIG. 1. The at least one salient object may be detected with a saliency detection algorithm. Also, the at least one salient object may be detected based on at least one saliency dataset of a ground truth of pixels. Further, detecting the at least one salient object in the downsampled image may include: processing the plurality of downsampled pixels in the downsampled image. The at least one salient object may be more noticeable or conspicuous to a human eye compared to one or more other objects in the downsampled image.

At 1010, the GPU may configure a saliency map based on the at least one salient object in the downsampled image, as described in connection with the examples in FIGS. 1-8. For example, as described in 850 of FIG. 8, GPU 802 may configure a saliency map based on the at least one salient object in the downsampled image. Further, step 1010 may be performed by processing unit 120 in FIG. 1. The saliency map may be configured based on a portion of the at least one salient object, such that the saliency map is configured based on less than all of the at least one salient object.

At 1012, the GPU may divide the at least one salient object into a plurality of salient object portions based on a mask, where the mask is associated with the saliency map, and the at least one salient object is divided to adjust the color value of the at least one downsampled pixel, as described in connection with the examples in FIGS. 1-8. For example, as described in 860 of FIG. 8, GPU 802 may divide the at least one salient object into a plurality of salient object portions based on a mask, where the mask is associated with the saliency map, and the at least one salient object is divided to adjust the color value of the at least one downsampled pixel. Further, step 1012 may be performed by processing unit 120 in FIG. 1. The at least one salient object may be divided into the plurality of salient object portions further based on a neural network (NN) or a machine learning (ML) model.

At 1014, the GPU may adjust, based on the saliency map, a color value of at least one downsampled pixel of the one or more downsampled pixels in the at least one salient object, as described in connection with the examples in FIGS. 1-8. For example, as described in 870 of FIG. 8, GPU 802 may adjust, based on the saliency map, a color value of at least one downsampled pixel of the one or more downsampled pixels in the at least one salient object. Further, step 1014 may be performed by processing unit 120 in FIG. 1. The color value of the at least one downsampled pixel may be adjusted based on one or more of: at least one three dimensional (3D) lookup table (LUT) or one or more weights for the color value of the plurality of downsampled pixels. In some aspects, the at least one 3D LUT may include a plurality of 3D LUTs and the one or more weights may include a plurality of weights, where the color value of the at least one downsampled pixel may be adjusted based on a product of at least one of the plurality of 3D LUTs and at least one of the plurality of weights.

At 1016, the GPU may tune the input image based on the adjusted color value of the at least one downsampled pixel, as described in connection with the examples in FIGS. 1-8. For example, as described in 880 of FIG. 8, GPU 802 may tune the input image based on the adjusted color value of the at least one downsampled pixel. Further, step 1016 may be performed by processing unit 120 in FIG. 1. Tuning the input image based on the adjusted color value of the at least one downsampled pixel may include: enhancing the input image based on the adjusted color value of the at least one downsampled pixel.

At 1018, the GPU may transmit the tuned input image to a display or a panel; or store the tuned input image in a first memory or a buffer, as described in connection with the examples in FIGS. 1-8. For example, as described in 890 of FIG. 8, GPU 802 may transmit the tuned input image to a display or a panel; or store the tuned input image in a first memory or a buffer. Further, step 1018 may be performed by processing unit 120 in FIG. 1.

In configurations, a method or an apparatus for graphics processing is provided. The apparatus may be a GPU, a graphics processor, or some other processor that may perform graphics processing. In aspects, the apparatus may be the processing unit 120 within the device 104, or may be some other hardware within the device 104 or another device. The apparatus, e.g., processing unit 120, may include means for downsampling an input image including a plurality of pixels, the downsampled input image corresponding to a downsampled image including a plurality of downsampled pixels; means for detecting at least one salient object in the downsampled image, the at least one salient object including one or more downsampled pixels of the plurality of downsampled pixels; means for configuring a saliency map based on the at least one salient object in the downsampled image; means for adjusting, based on the saliency map, a color value of at least one downsampled pixel of the one or more downsampled pixels in the at least one salient object; means for tuning the input image based on the adjusted color value of the at least one downsampled pixel; means for dividing the at least one salient object into a plurality of salient object portions based on a mask, where the mask is associated with the saliency map, and the at least one salient object is divided to adjust the color value of the at least one downsampled pixel; means for analyzing the downsampled image with an eye-tracking device, where the at least one salient object is detected based on the analyzed downsampled image; means for obtaining the input image including the plurality of pixels prior to downsampling the input image, where the input image is associated with display processing; means for transmitting the tuned input image to a display or a panel; and means for storing the tuned input image in a first memory or a buffer.

The subject matter described herein may be implemented to realize one or more benefits or advantages. For instance, the described graphics processing techniques may be used by a GPU, a DPU, an image or graphics processor, or some other processor that may perform image or graphics processing to implement the saliency-based adaptive color enhancement techniques described herein. This may also be accomplished at a low cost compared to other image or graphics processing techniques. Moreover, the image or graphics processing techniques herein may improve or speed up data processing or execution. Further, the image or graphics processing techniques herein may improve resource or data utilization and/or resource efficiency. Additionally, aspects of the present disclosure may utilize saliency-based adaptive color enhancement techniques in order to improve memory bandwidth efficiency and/or increase processing speed at a GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for image processing including at least one processor coupled to a memory and configured to: downsample an input image including a plurality of pixels, the downsampled input image corresponding to a downsampled image including a plurality of downsampled pixels; detect at least one salient object in the downsampled image, the at least one salient object including one or more downsampled pixels of the plurality of downsampled pixels; configure a saliency map based on the at least one salient object in the downsampled image; adjust, based on the saliency map, a color value of at least one downsampled pixel of the one or more downsampled pixels in the at least one salient object; and tune the input image based on the adjusted color value of the at least one downsampled pixel.

Aspect 2 is the apparatus of aspect 1, where the at least one processor is further configured to: divide the at least one salient object into a plurality of salient object portions based on a mask, where the mask is associated with the saliency map, and the at least one salient object is divided to adjust the color value of the at least one downsampled pixel.

Aspect 3 is the apparatus of any of aspects 1 and 2, where the at least one salient object is divided into the plurality of salient object portions further based on a neural network (NN) or a machine learning (ML) model.

Aspect 4 is the apparatus of any of aspects 1 to 3, where the color value of the at least one downsampled pixel is adjusted based on one or more of: at least one three dimensional (3D) lookup table (LUT) or one or more weights for the color value of the plurality of downsampled pixels.

Aspect 5 is the apparatus of any of aspects 1 to 4, where the at least one 3D LUT includes a plurality of 3D LUTs and the one or more weights include a plurality of weights, and where the color value of the at least one downsampled pixel is adjusted based on a product of at least one of the plurality of 3D LUTs and at least one of the plurality of weights.

Aspect 6 is the apparatus of any of aspects 1 to 5, where the at least one processor is further configured to: analyze the downsampled image with an eye-tracking device, where the at least one salient object is detected based on the analyzed downsampled image.

Aspect 7 is the apparatus of any of aspects 1 to 6, where the at least one salient object is detected with a saliency detection algorithm.

Aspect 8 is the apparatus of any of aspects 1 to 7, where the at least one salient object is detected based on at least one saliency dataset of a ground truth of pixels.

Aspect 9 is the apparatus of any of aspects 1 to 8, where to detect the at least one salient object in the downsampled image, the at least one processor is configured to: process the plurality of downsampled pixels in the downsampled image.

Aspect 10 is the apparatus of any of aspects 1 to 9, where the input image is a high resolution image and the downsampled image is a low resolution image.

Aspect 11 is the apparatus of any of aspects 1 to 10, where the high resolution image includes greater than 300 pixels per inch (ppi) and the low resolution image includes less than 300 ppi.

Aspect 12 is the apparatus of any of aspects 1 to 11, where the at least one salient object is more noticeable or conspicuous to a human eye compared to one or more other objects in the downsampled image.

Aspect 13 is the apparatus of any of aspects 1 to 12, where to tune the input image based on the adjusted color value of the at least one downsampled pixel, the at least one processor is configured to: enhance the input image based on the adjusted color value of the at least one downsampled pixel.

Aspect 14 is the apparatus of any of aspects 1 to 13, where the saliency map is configured based on a portion of the at least one salient object, such that the saliency map is configured based on less than all of the at least one salient object.

Aspect 15 is the apparatus of any of aspects 1 to 14, where the at least one processor is further configured to: obtain the input image including the plurality of pixels prior to downsampling the input image, where the input image is associated with image processing or display processing.

Aspect 16 is the apparatus of any of aspects 1 to 15, where the at least one processor is further configured to: transmit the tuned input image to a display or a panel; or store the tuned input image in a first memory or a buffer.

Aspect 17 is the apparatus of any of aspects 1 to 16, where the apparatus is a wireless communication device, further including at least one of an antenna or a transceiver coupled to the at least one processor.

Aspect 18 is a method of graphics processing for implementing any of aspects 1 to 17.

Aspect 19 is an apparatus for graphics processing including means for implementing any of aspects 1 to 17.

Aspect 20 is a non-transitory computer-readable medium storing computer executable code, the code when executed by at least one processor causes the at least one processor to implement any of aspects 1 to 17.

What is claimed is:

1. An apparatus for image processing, comprising:
a memory; and
at least one processor coupled to the memory and configured to:
downsample an input image including a plurality of pixels, the downsampled input image corresponding to a downsampled image including a plurality of downsampled pixels;
detect at least one salient object in the downsampled image, the at least one salient object including one or more downsampled pixels of the plurality of downsampled pixels;
configure a saliency map based on the at least one salient object in the downsampled image;
adjust, based on the saliency map, a color value of at least one downsampled pixel of the one or more downsampled pixels in the at least one salient object; and
tune the input image based on the adjusted color value of the at least one downsampled pixel.

2. The apparatus of claim 1, wherein the at least one processor is further configured to:
divide the at least one salient object into a plurality of salient object portions based on a mask, wherein the mask is associated with the saliency map, and the at least one salient object is divided to adjust the color value of the at least one downsampled pixel.

3. The apparatus of claim 2, wherein the at least one salient object is divided into the plurality of salient object portions further based on a neural network (NN) or a machine learning (ML) model.

4. The apparatus of claim 1, wherein the color value of the at least one downsampled pixel is adjusted based on one or more of: at least one three dimensional (3D) lookup table (LUT) or one or more weights for the color value of the plurality of downsampled pixels.

5. The apparatus of claim 4, wherein the at least one 3D LUT includes a plurality of 3D LUTs and the one or more weights include a plurality of weights, and wherein the color value of the at least one downsampled pixel is adjusted based on a product of at least one of the plurality of 3D LUTs and at least one of the plurality of weights.

6. The apparatus of claim 1, wherein the at least one processor is further configured to:
analyze the downsampled image with an eye-tracking device, wherein the at least one salient object is detected based on the analyzed downsampled image.

7. The apparatus of claim 1, wherein the at least one salient object is detected with a saliency detection algorithm.

8. The apparatus of claim 1, wherein the at least one salient object is detected based on at least one saliency dataset of a ground truth of pixels.

9. The apparatus of claim 1, wherein to detect the at least one salient object in the downsampled image, the at least one processor is configured to: process the plurality of downsampled pixels in the downsampled image.

10. The apparatus of claim 1, wherein the input image is a high resolution image and the downsampled image is a low resolution image.

11. The apparatus of claim 10, wherein the high resolution image includes greater than 300 pixels per inch (ppi) and the low resolution image includes less than 300 ppi.

12. The apparatus of claim 1, wherein the at least one salient object is more noticeable or conspicuous to a human eye compared to one or more other objects in the downsampled image.

13. The apparatus of claim 1, wherein to tune the input image based on the adjusted color value of the at least one downsampled pixel, the at least one processor is configured to: enhance the input image based on the adjusted color value of the at least one downsampled pixel.

14. The apparatus of claim 1, wherein the saliency map is configured based on a portion of the at least one salient object, such that the saliency map is configured based on less than all of the at least one salient object.

15. The apparatus of claim 1, wherein the at least one processor is further configured to:
obtain the input image including the plurality of pixels prior to downsampling the input image, wherein the input image is associated with the image processing or display processing.

16. The apparatus of claim 1, wherein the at least one processor is further configured to:
transmit the tuned input image to a display or a panel; or
store the tuned input image in a first memory or a buffer.

17. The apparatus of claim 1, wherein the apparatus is a wireless communication device, further comprising at least one of an antenna or a transceiver coupled to the at least one processor.

18. A method of image processing, comprising:
downsampling an input image including a plurality of pixels, the downsampled input image corresponding to a downsampled image including a plurality of downsampled pixels;
detecting at least one salient object in the downsampled image, the at least one salient object including one or more downsampled pixels of the plurality of downsampled pixels;
configuring a saliency map based on the at least one salient object in the downsampled image;
adjusting, based on the saliency map, a color value of at least one downsampled pixel of the one or more downsampled pixels in the at least one salient object; and
tuning the input image based on the adjusted color value of the at least one downsampled pixel.

19. The method of claim 18, further comprising:
dividing the at least one salient object into a plurality of salient object portions based on a mask, wherein the mask is associated with the saliency map, and the at least one salient object is divided to adjust the color value of the at least one downsampled pixel, and wherein the at least one salient object is divided into the plurality of salient object portions further based on a neural network (NN) or a machine learning (ML) model.

20. The method of claim 18, wherein the color value of the at least one downsampled pixel is adjusted based on one or more of: at least one three dimensional (3D) lookup table (LUT) or one or more weights for the color value of the plurality of downsampled pixels, and wherein the at least one 3D LUT includes a plurality of 3D LUTs and the one or more weights include a plurality of weights, and wherein the color value of the at least one downsampled pixel is adjusted based on a product of at least one of the plurality of 3D LUTs and at least one of the plurality of weights.

21. The method of claim 18, further comprising:
analyzing the downsampled image with an eye-tracking device, wherein the at least one salient object is detected based on the analyzed downsampled image.

22. The method of claim 18, wherein the at least one salient object is detected with a saliency detection algorithm or the at least one salient object is detected based on at least one saliency dataset of a ground truth of pixels.

23. The method of claim 18, wherein detecting the at least one salient object in the downsampled image comprises: processing the plurality of downsampled pixels in the downsampled image.

24. The method of claim 18, wherein the input image is a high resolution image and the downsampled image is a low resolution image, and wherein the high resolution image includes greater than 300 pixels per inch (ppi) and the low resolution image includes less than 300 ppi.

25. The method of claim 18, wherein the at least one salient object is more noticeable or conspicuous to a human eye compared to one or more other objects in the downsampled image, and wherein the saliency map is configured based on a portion of the at least one salient object, such that the saliency map is configured based on less than all of the at least one salient object.

26. The method of claim 18, wherein tuning the input image based on the adjusted color value of the at least one downsampled pixel comprises: enhancing the input image based on the adjusted color value of the at least one downsampled pixel.

27. The method of claim 18, further comprising:
obtaining the input image including the plurality of pixels prior to downsampling the input image, wherein the input image is associated with the image processing or display processing.

28. The method of claim 18, further comprising:
transmitting the tuned input image to a display or a panel; or
storing the tuned input image in a first memory or a buffer.

29. An apparatus for image processing, comprising:
means for downsampling an input image including a plurality of pixels, the downsampled input image corresponding to a downsampled image including a plurality of downsampled pixels;
means for detecting at least one salient object in the downsampled image, the at least one salient object including one or more downsampled pixels of the plurality of downsampled pixels;
means for configuring a saliency map based on the at least one salient object in the downsampled image;
means for adjusting, based on the saliency map, a color value of at least one downsampled pixel of the one or more downsampled pixels in the at least one salient object; and
means for tuning the input image based on the adjusted color value of the at least one downsampled pixel.

30. A computer-readable medium storing computer executable code for image processing, the code when executed by a processor causes the processor to:
downsample an input image including a plurality of pixels, the downsampled input image corresponding to a downsampled image including a plurality of downsampled pixels;
detect at least one salient object in the downsampled image, the at least one salient object including one or more downsampled pixels of the plurality of downsampled pixels;
configure a saliency map based on the at least one salient object in the downsampled image;
adjust, based on the saliency map, a color value of at least one downsampled pixel of the one or more downsampled pixels in the at least one salient object; and
tune the input image based on the adjusted color value of the at least one downsampled pixel.
